(19) United States
(12) Patent Application Publication
(10) Pub. No.: US 2021/0109973 A1
(43) Pub. Date: Apr. 15, 2021

(54) GENERATION OF GRAPH-STRUCTURED REPRESENTATIONS OF BROWNFIELD SYSTEMS

(71) Applicants: Georgia Olympia Brikis, München (DE); Serghei Mogoreanu, München (DE); Martin Ringsquandl, Rosenheim (DE)

(72) Inventors: Georgia Olympia Brikis, München (DE); Serghei Mogoreanu, München (DE); Martin Ringsquandl, Rosenheim (DE)

(21) Appl. No.: 17/066,879

(22) Filed: Oct. 9, 2020

(30) Foreign Application Priority Data
Oct. 10, 2019 (EP) 19202473.5

(51) Int. Cl. G06F 16/901; G06N 3/08

(52) U.S. Cl. CPC G06F 16/9024; G06N 3/08

(57) ABSTRACT

A method for generating graph-structured representations of a brownfield system including collecting training data of training systems. Training data includes training pairs, with each training pair including training sensor observations and a training digital twin model. The method includes transforming the training digital twin models into training graph-structured representations. The training graph-structured representations include nodes and links. The nodes represent components of the training system and the links represent relations between the components of the training system. A graph generative model is trained to generate graph-structured representations of the brownfield system using the training sensor observations and the training graph-structured representations of the training digital twin models. Graph-structured representations of the brownfield system are generated using the trained graph generative model and sensor observations of the brownfield system.

### CROSS REFERENCE TO RELATED APPLICATIONS

This patent document claims the benefit of EP19202473 filed on Oct. 10, 2019 which is hereby incorporated in its entirety by reference

### FIELD

Embodiments relate to a computerized method for generating graph-structured representations of a brownfield system.

### BACKGROUND

Digital documentation for many products that are in-use today is either not available at all or it is of low quality, e.g. unstructured text, scanned 2-D plans, etc. Having a structured digital documentation (digital twin model) of the brownfield assets/brownfield systems is very important for monitoring, maintenance, modernization and reproduction. The retrospective re-engineering of digital twin models of brownfield assets is a major problem for at least three reasons: it requires extensive manual effort of domain experts (that is not only expensive, but in some cases such expertise may no longer be available), the asset needs to be dismantled, maybe even destroyed (and therefore is not in-use during that time), and the process of acquiring, processing and consolidating existing documentation requires a lot of manual effort and often leads to inconsistencies or reveals missing information.

### SUMMARY

Embodiments provide a method to generate a digital documentation of brownfield systems. The scope of the present invention is defined solely by the appended claims and is not affected to any degree by the statements within this summary. The present embodiments may obviate one or more of the drawbacks or limitations in the related art.

Embodiments provide automatic generation of graph-structured representations of brownfield systems from sensor observations of brownfield systems using a machine learning generative model.

In an embodiment, a computerized method for generating graph-structured representations of a brownfield system is provided. The method includes: collecting training data of training systems, wherein training data includes of training pairs, with each training pair including training sensor observations and a training digital twin model, transforming the training digital twin models into training graph-structured representations, wherein the training graph-structured representations include nodes and links, wherein the nodes represent components of the training system and wherein the links represent relations or interactions between the components of the training system (give context information on how the components relate to each other or interact with each other), training a graph generative model to generate graph-structured representations of the brownfield system using the training sensor observations and the training graph-structured representations of the training digital twin models, and generating graph-structured representations of the brownfield system using the trained graph generative model and sensor observations of the brownfield system.

3D models and simulation models (e.g. training digital twin models) include implicit structures that may be interpreted as links between components. For 3D models, geometric distance may be abstracted locally by linking components that are “close” in terms of geometric distance (e.g. a room is connected to another one, because they are located next to each other).

For simulation models, physical connections between components are usually explicitly represented by the simulation environment. These connections may be readily regarded as links in a graph (e.g. the flow of the gas path in a gas turbine is explicitly modelled as an equation parameterized by the corresponding compressor state and burner tip temperature, so there's a link between this compressor and the burner tip).

The graph generative model may be trained following a standard policy gradient procedure in a generative adversarial approach. By maximizing a reward signal from a graph discriminator network, thereby approximating the original distribution of digital twin graphs (digital twin models transferred into training graph-structured representations) in the training data.

The training procedure may be described as follows: Sampled sensor observations from the training data are fed as input to a sensor encoder of the graph generative model (e.g. Long-short-term-memory (LSTMs) may be used to get encodings of multi-variate sensor observations). A graph decoder network takes the encoded sensor observations and maps them to a graph structure (e.g. Graph Convolutional Policy Network (GCPN) may be used for this). A Graph Discriminator network estimates how close the generated graph is to the original example from the training data. The estimation is used as reward for the graph generative model. Once the GCPN pulls a stop action (or after a maximum number of steps), a corresponding final generated graph is fed into a queue of “fake” generated examples. The “fake” example queue is used to train a graph discriminator network in parallel to the graph generative model—e.g. a generative adversarial network (GAN) training model.

Sensor observations or operational data of the brownfield system/asset may exist from either direct or indirect sensor monitoring. The method provides a generative machine learning model that relies on pairs of sensor observations/operational data and graph-structured digital twins (digital twin models transformed into training graph-structured representations) for training. Such pairs of training data are available for newer assets that already come with a digital twin and sensor observations. The generative machine learning model outputs graphs conditioned on the sensor observations as input. After training, the generative machine learning model may then be applied to brownfield systems/assets for which only sensor observations or operational data is available.

The digital twin models are transformed into training graph-structured representations, because graphs are universal data structures that are best suited to represent entities in relation with rich context information. The choice of graphs as the underlying data representation model for the generated digital twins is motivated not only the fact that graphs are the most natural way to represent complex (i.e. including a multitude of components) systems, but also their flexibility: depending on the available amount of training data, graphs may represent the asset on an abstract or highly detailed level.

According to an embodiment the graph generative model is configured as a generative deep neural network model or an encoder-decoder deep neural network. An encoder-decoder deep neural network follows an encoder-decoder (autoencoder) framework of “deep” neural network architectures (e.g. Graph Variational Auto-Encoder, Graph Convolutional Policy Network).

According to an embodiment the training digital twin models and the brownfield system is a building, a production asset, or a plant.

According to an embodiment the training sensor observations and the sensor observations of the brownfield system is/are operational data, power consumption data, Wi-Fi-signals, temperature measurements, CO2/NOX levels, and/or control system alarms and events.

According to an embodiment the operational data is observed by vibration sensors, temperature sensors, and/or microphones.

According to an embodiment the generated graph-structured representations of the brownfield system include structural and/or topographical information of the brownfield system.

According to an embodiment the graph-structured representations of the brownfield system are used for monitoring, maintenance, modernization and/or reproduction of the brownfield system.

The three use cases described in the following may benefit. Brownfield buildings: Wi-Fi-signals (frequency of Wi-Fi signal may be measured and reflect locations and movements of persons) in buildings (brownfield sensor observations) indirectly monitor building topology, e.g. room layout, pathways, doors, etc. from which a digital building twin may be derived with the purposed method.

Some newer buildings come with graph-structured building information models (training digital twin models/training graph-structured representations, e.g. BIM IFC, Autodesk Revit) and store sensor data/sensor observations such as Wi-Fi-signals (training sensor observations). The pairs may be used as the training data for learning how to generate digital twins of (older) brownfield buildings (graph-structured representations of a brownfield system).

Secondly, brownfield production equipment: Brownfield production assets (e.g. motors) are monitored by attaching a variety of sensors (e.g. vibration sensors, temperature sensors, microphones) to the outer shell of the machine (brownfield sensor observations). The readings of the sensors are used for monitoring the asset's health, scheduling its maintenance, as well as estimating crucial metrics such as the remaining lifespan. Some of the tasks also rely on the availability of the corresponding simulation model that reflects the behaviour of the asset under certain operational and environmental conditions. Creating such a model is impossible without a digital twin reflecting the asset's structure—that is why some of the monitoring tasks cannot be performed on older brownfield assets for which such data is not available.

More recent models of machines come with dedicated 3D models (training digital twin model) that may also be represented as a graph (training graph-structured representations) and similar sensor observations (training sensor observations), that again may be exploited as pairs of training data.

Thirdly, Brownfield plants: The power consumption of plants (e.g. switchgear plants, process industry plants) is monitored and assessed using sensors (brownfield sensor observations) placed at different devices and transmission lines within the plant. The measurements taken may be used to meet power consumption requirements but are also a valuable indicator of device/plant health. However, not every device in a plant may be equipped with a separate sensor. Thus, some sensors measure the power consumed by several devices e.g. connected in series. To identify and properly assess such sensor measurements knowledge of the plant topology is necessary. In Brownfield plants information on the plant's topological setup does often not exist or is not up to date.

Newly configured plants come with topological plans (training digital twin model) while being equipped with sensors for power usage measuring (training sensor observations). The topological information of these plants (training digital twin model) may be transformed into graph representations (training graph-structured representations) and together with the sensory information (training sensor observations) exploited for training a model. The learned model may provide the extraction of a plant's topology from power consumption sensor measurements (generating graph-structured representations of a brownfield system), e.g. in the case of Brownfield plants without pre-existing topological plants.

Some advantages of the purposed method include where the trained generative model provides to re-construct structured representation of brownfield assets automatically, requiring little to no manual effort (cost and time reduction). Re-constructed digital twins enable to reproduce, more efficiently maintain and monitor brownfield assets that are not well-documented. The choice of generating graph structures rather than 3D models gives the method more flexibility in the representation that may be of different levels of detail depending on the amount of training data available. Further, employing a generation model ends up with a representation for brownfield asset that includes the same makeup as the representations used for training, providing for comparability and application of potentially already existing analytical models, visualization, etc.

### BRIEF DESCRIPTION OF THE FIGURES

FIG. 1 depicts a flow diagram of the computerized method for generating graph-structured representations of a brownfield system according to an embodiment.

FIG. 2 depicts a flow diagram of generating graph-structured representations of a brownfield building according to an embodiment.

FIG. 3 depicts collected sensor observations (Wi-Fi signals) of a brownfield building according to an embodiment.

FIG. 4 depicts a generated graph-structured representation of a brownfield building using a trained graph generative model and sensor observations of the brownfield building according to an embodiment.

FIG. 5 depicts a flow diagram of the general procedure of training a graph generative model according to an embodiment.

### DETAILED DESCRIPTION

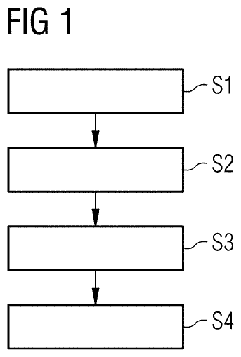

FIG. 1 depicts a flow diagram of the computerized method for generating graph-structured representations of a brownfield system. The computerized method includes the following steps: Step 1 M1: Collecting training data of training systems, wherein training data includes of training pairs, with each training pair including training sensor observations and a training digital twin model. Step 2 M2: transforming the training digital twin models into training graph-structured representations, wherein the training graph-structured representations consist of nodes and links, wherein the nodes represent components of the training system and wherein the links represent relations between the components of the training system. Step 3 M3: training a graph generative model to generate graph-structured representations of the brownfield system using the training sensor observations and the training graph-structured representations of the training digital twin models/Step 4 M4: generating graph-structured representations of the brownfield system using the trained graph generative model and sensor observations of the brownfield system.

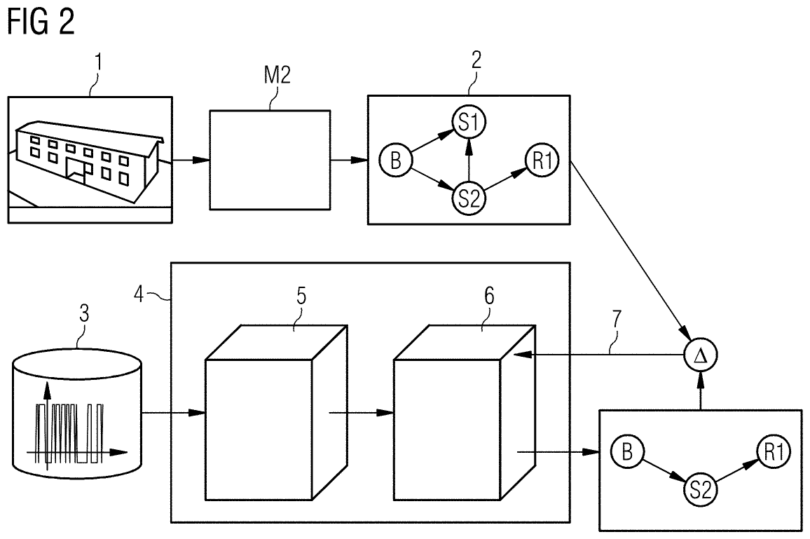

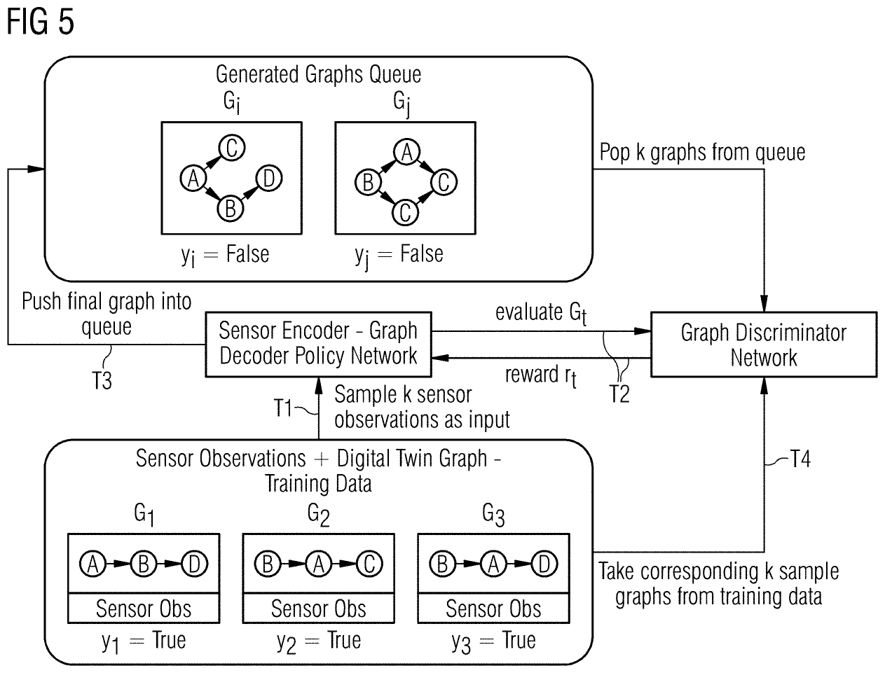

FIG. 2 depicts a flow diagram of generating graph-structured representations of a brownfield building: training digital twin models 1 are transformed (during Step 2 M2) into training graph-structured representations 2. Training data pairs, each of a training graph-structured representation 2 and training sensor observations 3 are input into a graph generative model 4. The graph generative model 4 may be configured as an encoder-decoder deep neural network with a sensor encoder network 5 and a graph decoder network 6. The graph generative model 4 may follow the encoder-decoder framework to sample graph-structured representation of a brownfield building conditioned on sensor observations of the brownfield building. During training of the graph generative model 4 an error feedback 7 is given on how close the graph-structured representation of the brownfield building is to the original example of the training graph-structured representations 2 from the training data. The training procedure is described in more detail in FIG. 5.

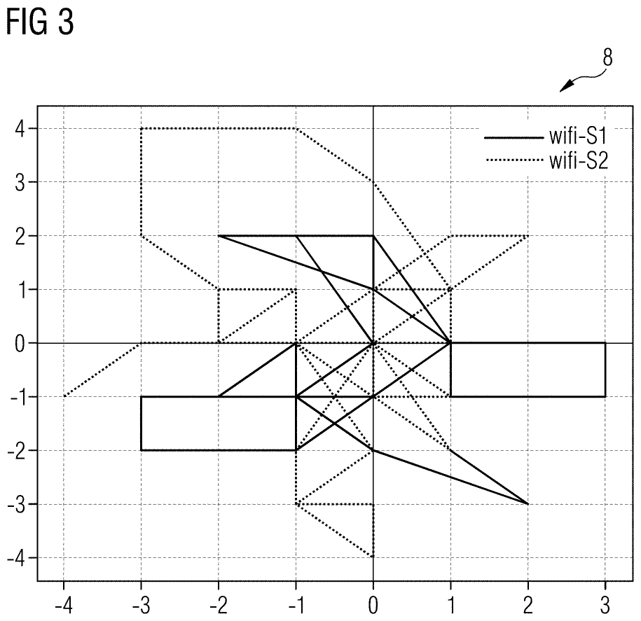

FIG. 3 depicts collected sensor observations of a brownfield building 8: Wi-Fi-signals from mobile phone clients reveal (x, y)-coordinates from which building topology may be derived. In this case, FIG. 3 includes two Wi-Fi networks for story S1 and story S2.

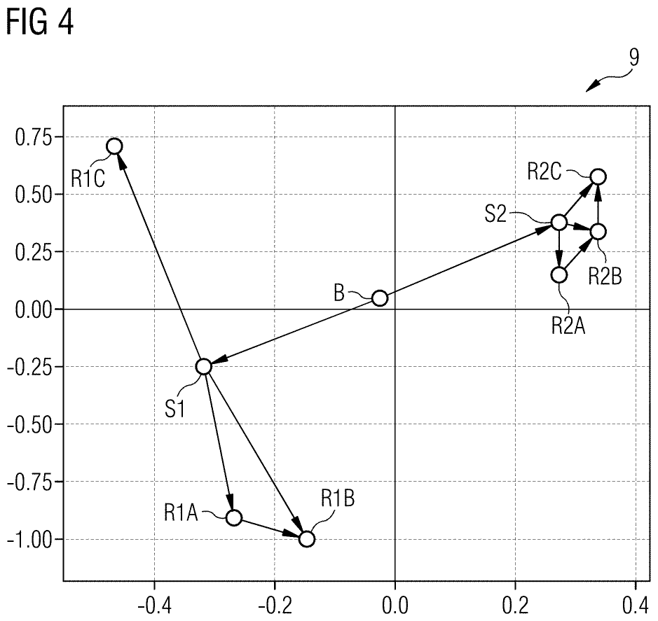

FIG. 4 depicts a generated graph-structured representation of a brownfield building 9 (example building topology as graph) using a trained graph generative model and sensor observations of the brownfield building: One building (represented as a node B), two stories (nodes S1 and S2), each with three rooms (R1A, R1B, R1C belonging to S1; R2A, R2B, R2C belonging to S2), and pathways that connect rooms (edges between the corresponding nodes).

FIG. 5 depicts a flow diagram of the general procedure of training a graph generative model. The graph generative model may be trained following a standard policy gradient procedure in a generative adversarial approach. By maximizing a reward signal from a graph discriminator network, thereby approximating the original distribution of digital twin graphs (digital twin models transferred into training graph-structured representations) in the training data.

This training procedure may be described as follows:

Training step 1 T1: Sampled sensor observations from the training data are input as input to a sensor encoder of the graph generative model (e.g. Long-short-term-memory (LSTMs) may be used to get encodings of multi-variate sensor observations).

Training step 2 T2: A graph decoder network takes the encoded sensor observations and maps the observations to a graph structure (e.g. Graph Convolutional Policy Network (GCPN) may be used for this). A Graph Discriminator network estimates how close the generated graph is to the original example from the training data. This estimation is used as reward for the graph generative model.

Training step 3 T3: Once the GCPN pulls a stop action (or after a maximum number of steps), a corresponding final generated graph is fed into a queue of “fake” generated examples.

Training step 4 T4: The “fake” example queue is used to train a graph discriminator network in parallel to the graph generative model—e.g. an example of a generative adversarial network (GAN) training.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for generating graph-structured representations of a brownfield system, the method comprising:
acquiring training data of training systems, the training data comprising training pairs, wherein each training pair comprising training sensor observations and a training digital twin model;
transforming the training digital twin models into training graph-structured representations, the training graph-structured representations comprising nodes and links, wherein the nodes represent components of the training system and the links represent relations between the components of the training system,
training a graph generative model to generate graph-structured representations of the brownfield system using the training sensor observations and the training graph-structured representations of the training digital twin models, and
generating graph-structured representations of the brownfield system using the trained graph generative model and sensor observations of the brownfield system.

2. The method of claim 1, wherein the graph generative model is configured as a generative deep neural network model or an encoder-decoder deep neural network.

3. The method of claim 1, wherein the training digital twin models and the brownfield system is a building, a production asset, or a plant.

4. The method of claim 2, wherein the training digital twin models and the brownfield system is a building, a production asset, or a plant.

5. The method of claim 4, wherein the training sensor observations and the sensor observations of the brownfield system comprise at least one of operational data, power consumption data, Wi-Fi-signal data, temperature measurement data, CO2/NOX level data, or control system alarms and events data.

6. The method of claim 5, wherein the operational data is acquired by vibration sensors, temperature sensors, or microphones.

7. The method of claim 6, wherein the graph-structured representations of the brownfield system are used for at least one of monitoring, maintenance, modernization or reproduction of the brownfield system.

8. The method of claim 1, wherein the training sensor observations and the sensor observations of the brownfield system comprise at least one of operational data, power consumption data, Wi-Fi-signal data, temperature measurement data, CO2/NOX level data, or control system alarms and events data.

9. The method of claim 1, wherein the generated graph-structured representations of the brownfield system include structural information, topographical information, or structural and topographical information of the brownfield system.

10. The method of claim 1, wherein the graph-structured representations of the brownfield system are used for at least one of monitoring, maintenance, modernization or reproduction of the brownfield system.
